(19) United States
(12) Patent Application Publication
(10) Pub. No.: US 2004/0031782 A1
(43) Pub. Date: Feb. 19, 2004

(54) Multi-door single chamber oven apparatus

(76) Inventor: Barbara Westfield, Chicago, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/219,855

(22) Filed: Aug. 15, 2002

(51) Int. Cl. F27D 11/00

(52) U.S. Cl. 219/391; 126/190

(57) ABSTRACT

A heating apparatus that includes a single heating chamber with an opening, and two or more independently moveable doors. Each door covers a portion of the chamber opening and selectively controls access through the chamber opening to a respective portion of the heating chamber.

### FIELD OF THE INVENTION

The present invention relates to ovens, and more particularly, to doors for an oven with a single heating chamber.

### BACKGROUND OF THE INVENTION

Attempting to cook or heat several different food items simultaneously on separate racks of the same oven is problematic for a typical household cook. Typically the different food items have different heating times or preparation requirements (e.g., adding an ingredient midway through the heating cycle of a food item), which dictate that the cook open the oven door to access the respective food item. Opening the door of a conventional household oven to access one of the several different food items heating therein, permits significant amounts of heat to escape the oven, prolonging the various heating cycles of all the food items.

In addition, the several different food items heating in the conventional household oven are typically placed on different vertically separated racks within the oven. The racks as well as the inside of the oven door become hot when the oven is heated. Thus, when reaching below to access a food item heating on a lower rack, the household cook may be burned by the hot inside of the opened oven door or by a hot upper rack.

Also, the household cook cannot easily remove the racks in the conventional household oven. Typically, the racks must be tilted while the household cook pulls them from the oven. Thus, food items heating on the racks are also not easily removed with the racks.

Furthermore, accessing one food item may accidentally cause an unwanted reaction in another food item that is heating simultaneously in the same conventional household oven. For example, a cake heating on a lower rack of the conventional household oven may “fall” or loose its shape, when the household cook opens the door of the oven to check on rolls warming on an upper rack of the same oven.

The problems identified above may be alleviated by using separate stacked ovens to cook several different food items simultaneously. Bakeries, pizza parlors, and various other commercial restaurants or food preparation establishments have separate ovens stacked to individually cook or heat several food items with different cooking times or different preparation requirements. The conventional commercial stacked ovens used in these food preparation establishments are housed in a single bay or cabinet, but each oven typically has separate heating controls and a single heating chamber with a separate, single door. Thus, the conventional commercial stacked ovens permit a baker or a cook to access a food item heating in one of the stacked ovens in order to add an ingredient or check if the food item is ready to be removed, without prolonging or disturbing the heating of any other food item that is heating in another of the stacked ovens.

While these conventional commercial stacked ovens permit several food items to be heated or cooked simultaneously, they are bulky and prohibitively expensive for use in the average home kitchen. Furthermore, stacking smaller ovens typically used in the average home kitchen is a costly alternative for individuals who infrequently wish to cook or heat several food items simultaneously. Thus, there is a need for an inexpensive oven that allows a household cook to access one of several food items heating simultaneously without being burned by a hot oven door and without significantly prolonging or disturbing the heating of the other food items.

### SUMMARY OF THE INVENTION

To overcome the above identified problems of a conventional household oven and other potential problems, a multi-door, single chamber heating apparatus consistent with the present invention is provided that allows a household cook to heat several different food items simultaneously and to access one of the food items heating therein by opening one of the oven doors while the remaining oven doors remain closed. Furthermore, a multi-door, single chamber heating apparatus consistent with the present invention also allows the household cook to remove one of the food items heating therein by opening and removing the one door with attached rack holding the one food item while the remaining oven doors remain closed.

In accordance with articles of manufacture consistent with the present invention, a heating apparatus is provided that includes a single heating chamber having an opening and a group of independently moveable doors. Each door covers a portion of the chamber opening and selectively controls access through the chamber opening to a respective portion of the heating chamber.

In one implementation, the heating apparatus may also include a group of racks. Each rack is adapted to hold an item to be heated and to be disposed within the chamber such that one of the racks is accessible when one of the doors is opened while the remaining one or more doors are closed to prevent access. The one accessible rack may be attached to the one door such that the one rack is at least partially removed from the chamber as the one door is opened and the one rack is completely disposed within the chamber when the one door is closed to cover the respective portion of the opening. Moreover, each rack may be attached to a respective door such that each rack and respective attached door is removable from the chamber and is interchangeable with another rack attached to another door. In this implementation, heat within the chamber is at least partially inhibited from escaping between the at least two doors of the plurality of doors when the two doors are closed.

The heating apparatus may also include a latch disposed on one door and adapted to extend to engage another door so that the two doors move in unison such that racks attached to the two doors may be removed in unison.

In another implementation, the heating apparatus may also include a respective handle for each door and a handgrip configured to be removeably attached to two handles such that the two handles move in unison, allowing the corresponding two doors and attached racks to be removed in unison from the chamber.

In yet another implementation, the heating apparatus may also include a handle for each door. In this implementation, at least two of the handles are rotatably attached to a respective door such that each of the two handles may be removeably attachable to another door, allowing the corresponding doors and attached racks to be removed in unison from the chamber.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a front plan view of an exemplary oven embodying the present invention;

FIG. 2 depicts a side plan view of the oven in FIG. 1;

FIG. 3A depicts a top plan view of an oven illustrating one embodiment of a group of doors and a group of racks for the oven, where the group of doors are positioned side-by-side along a vertical axis of the oven and each door is pivotally mounted to the oven;

FIG. 3B depicts a cut-away view of the oven in FIG. 3A illustrating one embodiment for disabling power to a heating element of the oven when one of the doors is opened;

FIG. 4 depicts a perspective view of the oven in FIG. 1 illustrating another embodiment of a group of doors and a group of racks for the oven, where one door is hinged to pivot about a vertical axis of the oven and another door is hinged to pivot about a horizontal axis of the oven;

FIG. 5 depicts a perspective view of the oven in FIG. 1 illustrating another embodiment of a group of doors and a group of racks for the oven, where at least one rack is attached to a respective door;

FIG. 6 depicts a perspective view of the oven in FIG. 5 illustrating the one door with the attached rack removed from the oven and the remaining doors closed;

FIGS. 7A-B depict plan views of the oven in FIG. 5 illustrating one embodiment of a latch for attaching two or more doors together to enable the two or more doors to be removed from the oven in unison;

FIG. 8 depicts a plan view of the oven in FIG. 1 illustrating one embodiment of a latch for attaching two or more pivotably mounted doors together to enable the two or more doors to be opened in unison;

FIG. 9 depicts a plan view of the oven in FIG. 5 illustrating an embodiment of a handgrip to link separate handles of two oven doors to enable the two doors to be removed from the oven in unison;

FIG. 10A depicts a plan view of the oven in FIG. 5 illustrating an embodiment of handles that are each associated with one of the doors, where the handles each have a base and a grip that is detachable from the base;

FIG. 10B depicts a cut-away view of one of handles in FIG. 5 illustrating an embodiment for detaching the grip from the base of the one handle;

FIG. 10C depicts a plan view of the oven in FIG. 5 illustrating an embodiment of a handgrip that is attachable to two handle bases after a respective handle grip is removed from each of the two handle bases;

FIGS. 11A-B depict plan views of the oven in FIG. 5 illustrating another embodiment of handles that are each associated with one of the doors, where one handle has a latch that when extended engages another of the handles to enable the two associated doors to be removed from the oven in unison;

FIGS. 12A-B depict plan views of the oven in FIG. 5 illustrating another embodiment of handles that are each associated with one of the doors, where each handle is rotatably attached to a respective door such that each handle is removeably attachable to the respective door or to another door;

FIG. 13 depicts a perspective view of another exemplary oven illustrating another embodiment of a group of doors and a group of racks for the oven, where the group of doors are positioned side-by-side along a horizontal axis of the oven; and

FIG. 14 depicts a perspective view of the oven in FIG. 13 illustrating one of the group of doors removed from the oven and the remaining doors closed.

### DETAILED DESCRIPTION OF THE INVENTION

A multi-door, single chamber heating apparatus consistent with the present invention is provided that allows a household cook to heat different food items simultaneously, to access one of the food items heating therein by opening one of the oven doors while the remaining oven doors remain closed, and to remove one of the food items heating therein by opening and removing the one door with an attached rack holding the one food item while the remaining oven doors remain closed.

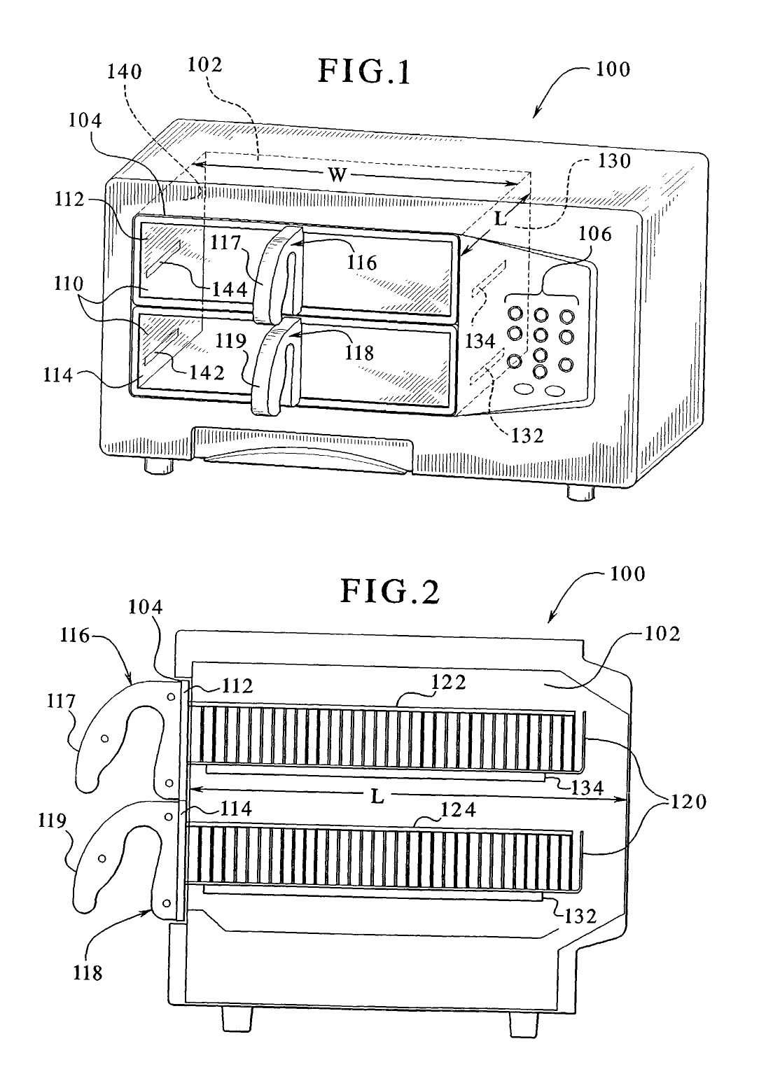

FIG. 1 depicts a front plan view of an exemplary heating apparatus or oven 100 embodying the present invention. As described herein, oven 100 may be a conventional electric or gas oven, a convection oven, or a combination radiant heat and convection oven that embodies aspects of the present invention as described below.

Oven 100 has a single heating chamber 102 that has an opening 104. The single heating chamber 102 is thermally associated with a heating source (not shown in FIG. 1), which may be any known heating source such as one or more electric heating elements or gas burners to provide means to radiantly heat the chamber. The heating chamber may also have an air flow source (not shown in FIG. 1), such as a fan, to provide a means for convectively heating the chamber. In addition, oven 100 has heating switches 106 that are operably connected to control the heating source. For clarity in understanding the present invention, it is not necessary to describe heating switches 106 in further detail.

As shown in FIG. 1, the heating chamber 102 and chamber opening 104 may have a rectangular, square, cylindrical, or other symmetrical shape. It is contemplated, however, that either the heating chamber 102 and the chamber opening 104 or both may be irregularly shaped.

Oven 100 includes a group of independently moveable doors 110. Each door 112 and 114 covers a portion of the chamber opening 104 and selectively controls access through the chamber opening 104 to a respective portion of the heating chamber 102. In one implementation, the doors 112 and 114 are disposed side-by-side such that heat within the chamber is at least partially inhibited from escaping between the two doors 112 and 114. In another implementation, oven 100 may have a cross member (not shown in figures) that connects opposing sides of chamber opening 104 so that the doors 112 and 114 may be spaced apart and still retain heat within the chamber when the doors 112 and 114 are closed.

To facilitate opening and closing of doors 112 and 114, they may also include handles 116 and 118 that are each attached to a respective door 112 and 114. Each handle 116 and 118 may have a grip 117 and 119. In another implementation, however, doors 112 and 114 may each have sides that may be gripped by a household cook to open and close the doors.

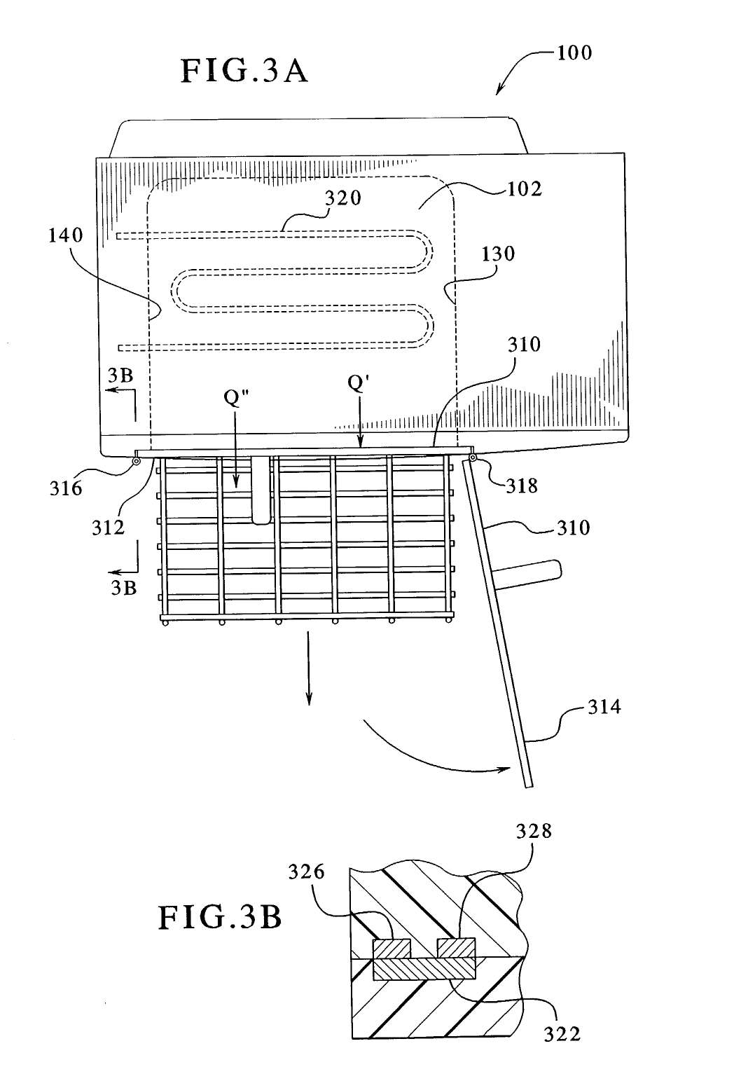

As shown in FIGS. 1 and 2, oven 100 further includes a group of racks 120. Each rack 122 and 124 is adapted to hold one or more items to be heated and to be disposed within the heating chamber 102 such that one of the racks 122 and 124 is accessible when one of the doors 112 and 114 is opened while the other of the doors 112 and 114 remains closed. The racks 120 may be made of metal, ceramic, or other thermally conductive material. The racks 120 may be solid or meshed. In addition, one or more of racks 120 may be a shaped as a basket or tray.

As shown in FIG. 2, racks 120 may extend the length (1) of the chamber 102 and may span the width (w) of the chamber 102. In another implementation, each rack 122 and 124 may have a width that spans the chamber but have a different length. In this implementation, chamber 102 may have sides 130 and 140 with protrusions 132, 134 and 142, 144 for each rack 122 and 124 to rest on when disposed within the chamber. Of course, sides 130 and 140 of chamber 102 may alternatively have recesses (not shown in figures) for each rack 122 and 124 to rest on when disposed within the chamber positioned similarly to the protrusions.

In yet another implementation, each rack 122 and 124 may be attached to a respective one of the doors 112 and 114 such that each rack 122 and 124 is independently supported by the respective door 112 and 114. In this implementation, each rack 122 and 124 may have a different length and a different width.

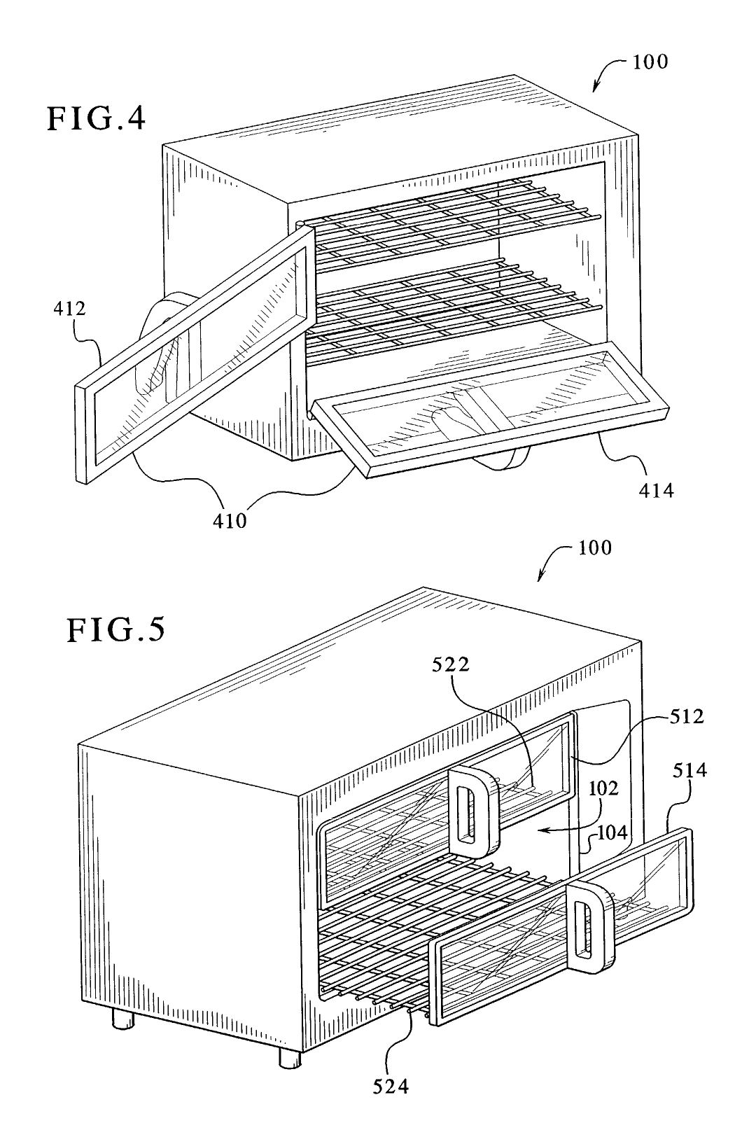

FIG. 3A depicts a top plan view of oven 100 that includes a group of doors 310 and a group of racks 320, where each door 312 and 314 is pivotally mounted so as to overlay the opening to hearing chamber 102. In the implementation shown in FIG. 3A, the doors 312 and 314 each have a hinge 316 and 318 mounted on opposing sides 140 and 130 of chamber 102 such that the doors 312 and 314 open in opposite directions. Of course, these hinges could also be located on the same side so as to allow both doors to open in the same direction. When one of the doors 312 and 314 is opened to allow access, heat from portions of the chamber 102 not accessible via the one door (e.g., heat portions Q′ where heat=Q′+Q″) is at least partially inhibited from escaping through the chamber 102 opening by the door that remains closed.

In some circumstances, it may be desirable to temporarily disable power to the heating element when a door is opened. FIG. 3B depicts a cut-away view of oven 100 illustrating one embodiment for disabling power to a heating element 320 of oven 100 when one of the doors 312 and 314 is opened. The heating element 320 is operably connected to heat the chamber when in an operating state and to automatically turn to an off state when one of the doors 312 and 314 are opened to allow access to the respective portion of the heating chamber. In the implementation shown in FIG. 3B, each door 312 and 314 has a metal strip 322. In addition, sides 140 and 130 of chamber 102 each has a respective set of contacts 326 and 328. The first contact 326 of each set may be electrically connected to a power supply (not shown in figures) and the second contact 328 of each set may be electrically connected to heating element 320. When doors 312 and 314 are closed, metal strip 322 electrically connects first contact 326 to second contact 328 in series so that heating element 320 may be turned to the operating state using heating controls 106. In this implementation, because each first contact 326 is connected in series to a respective second contact 328, opening either door 312 or door 314 breaks the connection between the power supply and heating element 320 such that heating element is turned to the off state.

Of course, it is understood that the first and second contacts may alternatively be used to complete an electrical connection for any signal path that enables the heating element 320 to be turned to the operating state when the doors 312 and 314 are closed and to break or disable the electrical connection for the enabling signal path when either of the doors 312 or 314 are opened.

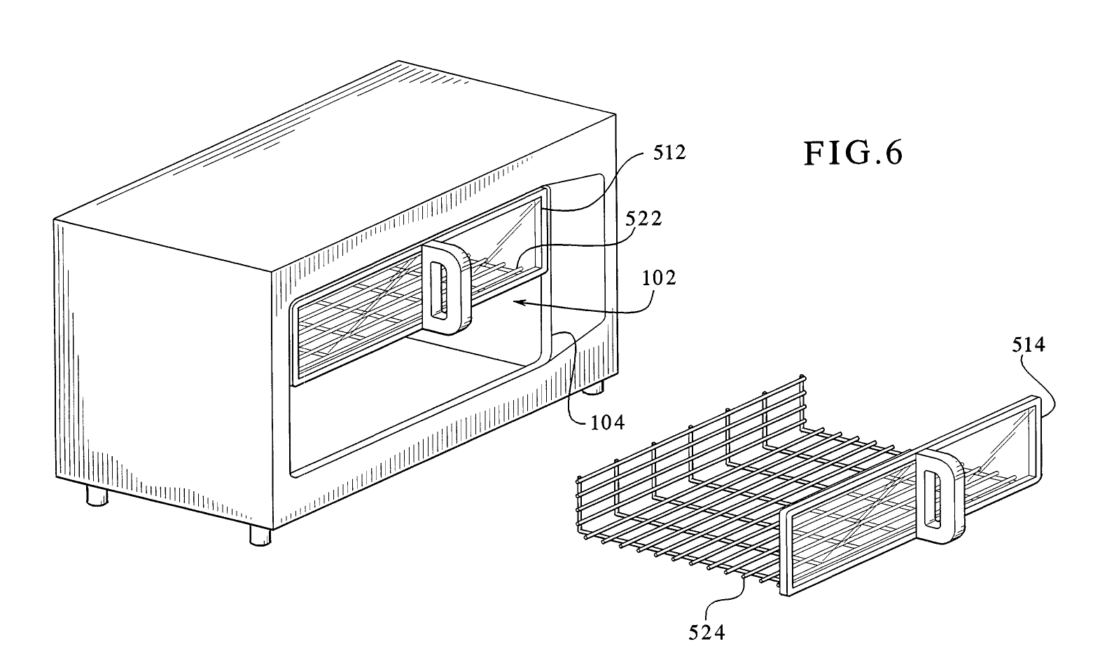

FIG. 4 depicts a perspective view of oven 100 illustrating another embodiment of a group of doors 410 for oven 100. In this implementation, one door 412 is hinged to pivot about a vertical axis of oven 100 and another door 414 is hinged to pivot about a horizontal axis of oven 100.

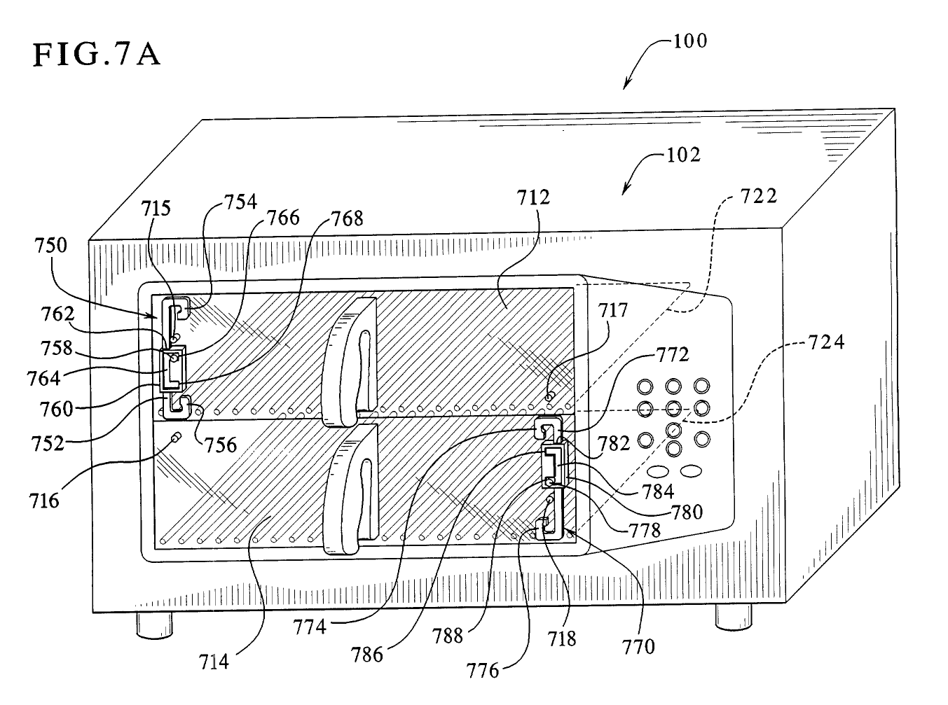

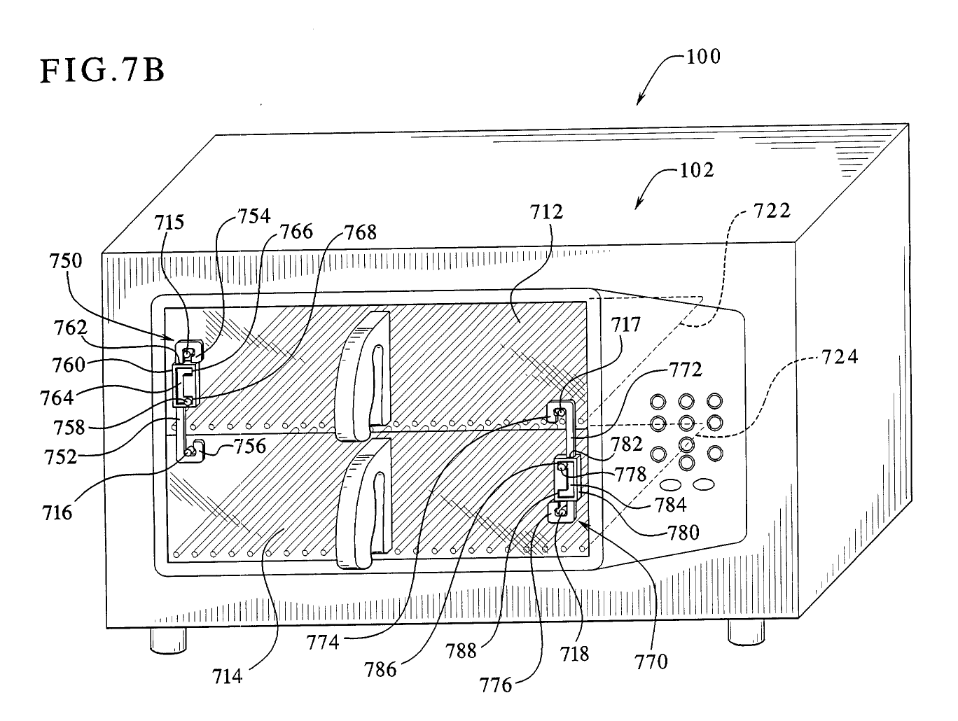

FIG. 5 depicts a perspective view of oven 100 illustrating another embodiment of a group of doors 512 and 514 and a group of racks 522 and 524 for oven 100. In this embodiment, at least one rack 524 is attached to a respective door 514 such that the one rack 524 may be at least partially removed from the chamber 102 as the door 514 is opened. When the door 514 is closed to cover the respective portion of the opening 104, the one rack 524 may be completely disposed within the chamber 102. In one implementation shown in FIG. 6, the door 514 may be opened such that the one rack 524 may be completed removed from the oven while the remaining door 512 is still closed. Thus, a household cook may access a food item heating on the one rack 524 without reaching into the chamber 102, which may be hot to the touch. Furthermore, the household cook may access the food item without significantly disturbing the heating of another item on the other rack 522, which is associated with the remaining closed door 512 and a different portion of the chamber.

In addition, each rack 522 and 524 may be attached to a respective door 512 and 514 such that each rack 522 and 524 may be removed from the chamber with the respective door 512 and 514 and then interchanged with another rack 512 or 514 attached to another door 522 or 524. Thus, a household cook may conveniently remove both racks 522 and 524 from chamber 102 and then subsequently replace them with other racks (not shown in figures) holding other food items to be heated in oven 100. Alternatively, after removing both racks 522 and 524 (e.g., to replace the food items to be heated), the household cook may interchange the position of racks 522 and 524 in chamber 102 when closing doors 522 and 524 to cover respective portions of the chamber opening 104.

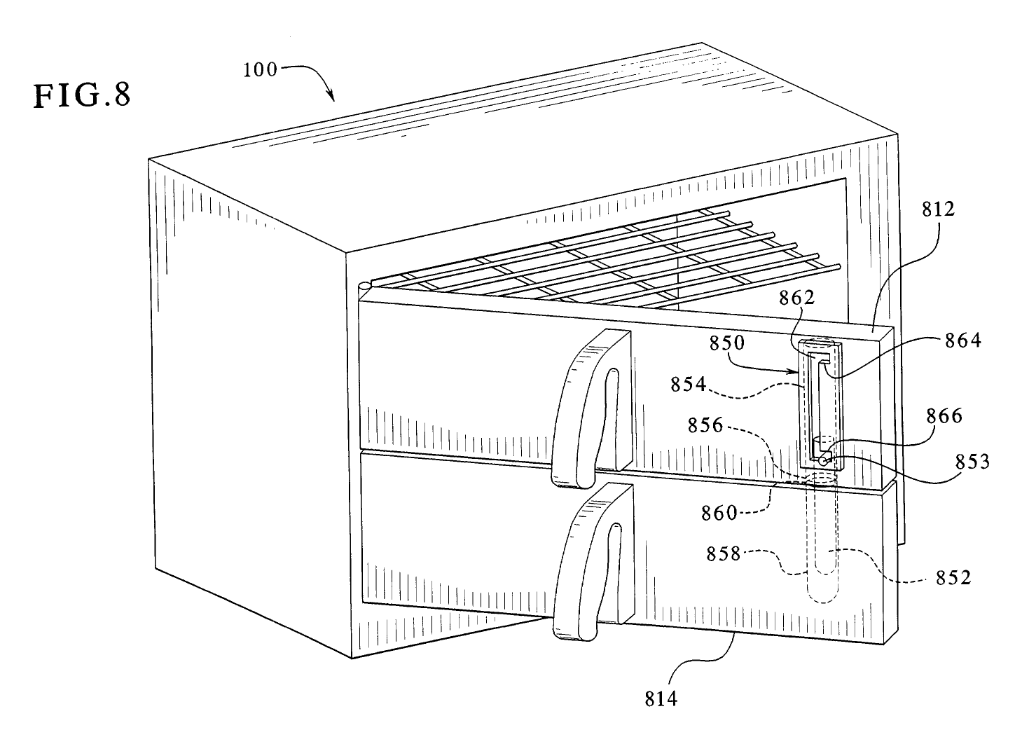

Referring now to FIGS. 7A-B, oven 100 may also include a latch 750, or more preferably two latches 750 and 770, for removing in unison at least two doors 712 and 714 from chamber 102. Latches 750 and 770 are each attached to a respective door 712 and 714 and are adapted to engage at least one other door, as shown in FIG. 7B, so that the doors 712 and 714 may be moved in unison. In the implementation shown in FIGS. 7A-B, each door 712, 714 has a respective knob 715, 716 that latch 750 may selectively engage as described below to allow doors 712, 714 to be moved in unison. Similarly, each door 712, 714 has a respective knob 717, 718 that latch 770 may selectively engage to allow doors 712, 714 to be moved in unison. In a preferred implementation, both latches 750 and 770 are used to selectively engage knobs 715, 716 and 717, 718 so that racks 722 and 724 attached to doors 712 and 714 may be completely removed from chamber 102 and carried to another location (e.g., where food items held on racks 722 and 724 may be easily accessed or removed by a household cook).

As shown in FIGS. 7A-B, each latch 750, 770 includes a bolt 752, 772 that has two bent ends 754, 756 and 774, 776 for engaging knobs 715, 716 and 717, 718, respectively. Each bolt 752, 772 also has a positioning rod 758, 778 that extends from bolt 752, 772. Each latch 750, 770 also includes a bracket 760, 780 that is attached to a respective door 712, 714. When attached to a respective door 712, 714, each latch 750 and 760 defines a sleeve 762, 782 through which bolt 752, 772 is disposed such that bolt 752, 772 may slide when moved via positioning rod 758, 778. Each bracket 760, 780 also has a travel path opening 764, 784 adapted to receive and to retain a respective positioning rod 758, 778 when bolt 752, 772 is disposed within sleeve 762, 782. Each travel path opening has two stops 766, 768 and 786, 788 for selectively retaining positioning rod 758, 778 such that bolt 752, 772 is prevented from sliding within sleeve 762, 782.

When positioning rod 758, 778 is moved to the first stop 766, 786 of travel path opening 764, 784, bolt 752, 772 is positioned such that bent ends 754, 756 and 774, 776 do not extend beyond door 712, 714. In a preferred implementation, bent ends 754, 756 and 774, 776 rest against door 712, 714 when positioning rod 758, 778 is moved to first stop 766, 786 of travel path opening 764, 784 as shown in FIG. 7A.

When positioning rod 758 is moved to second stop 768, bent ends 754, 756 of bolt 752 engage knob 715 of door 712 and knob 716 of door 714 allowing both doors 712, 714 to be moved in unison. Similarly, when positioning rod 778 is moved to second stop 788, bent ends 774, 776 of bolt 772 engage knob 717 of door 712 and knob 718 of door 714, allowing both doors 712, 714 to be moved in unison. As previously mentioned, both latches 750 and 770 are preferably used to engage both doors 712 and 714 so that racks 720 and 722 may be removed and be safely and easily carried to another location.

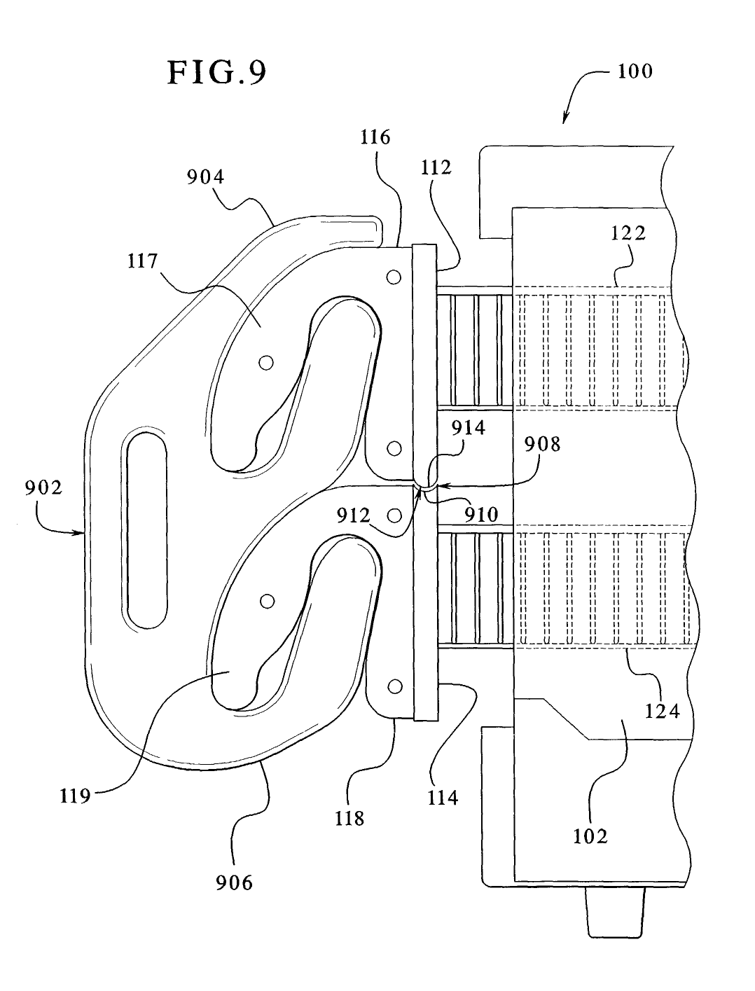

FIG. 8 depicts another implementation of a latch 850 for attaching together two or more pivotably mounted doors 812, 814 of oven 100 to enable the doors 812, 814 to be opened in unison. Doors 812, 814 may be pivotably mounted as previously described for door 412 in FIG. 4. Latch 850 includes a bolt 852 that has a positioning rod 854 extending from bolt 852. Door 812 has a bore 854 that has an opening 856. Door 814 has a complementary bore 858 that has an opening 860 that aligns with the bore opening 856 of door 812 when both doors are aligned vertically (e.g., such as when both doors are closed to cover chamber opening 104). Bore 854 in door 812 has a travel path opening 862 that is adapted to receive and to retain positioning rod 854 when bolt 852 is disposed within bore 854. Travel path opening 862 has two stops 864 and 866 to selectively retain positioning rod 854 such that bolt 852 is prevented from sliding within bore 854 or complementary bore 858.

When positioning rod 854 is moved to the first stop 864 of travel path opening 862, bolt 852 is positioned substantially within bore 854 of door 812 such that bolt 852 does not interfere with the independent movement of door 812.

When positioning rod 854 is moved to the second stop 866 of travel path opening 862 while doors 812 and 814 are vertically aligned, bolt 852 is positioned such that bolt 852 slides into complementary bore 858, allowing both doors 812, 814 to be opened in unison.

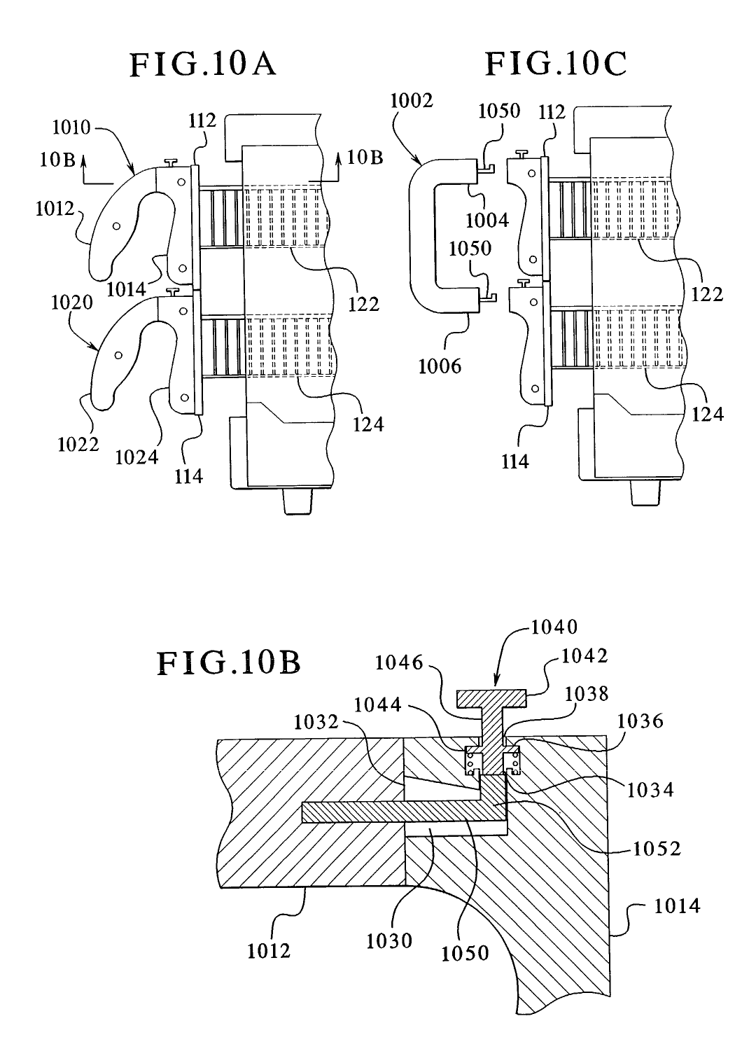

In another implementation shown in FIG. 9, oven 100 may include a handgrip 902 to physically but temporarily link handles 116 and 118 of oven doors 112 and 114 shown in FIG. 1, enabling handles 116, 118 to be moved in unison such that racks 122 and 124 may be simultaneously removed from oven 100. Handgrip 902 may comprise a material that is molded or formed to have a first portion 904 and a second portion 906 that may be removeably attached to a respective handle grip 117 and 119. The material of handgrip 902 may be any material (e.g., rubber or metal, preferably with insulated coating) having sufficient strength to hold racks 122 and 124 substantially parallel to each other when racks 122 and 124 are removed from chamber 102 via handgrip 902 linking handles 116 and 118.

In addition, door 114 may have an upper end 908 that has a recess 910. Door 112 may have a lower end 912 that has a shape or a protrusion 914 that is complementary to recess 910 such that protrusion 914 rests in and mates with recess 910 when racks 122 and 124 are removed from chamber 102. In this implementation, when protrusion 914 rests in and mates with recess 910, recess 910 is adapted to further hold racks 112 and 114 substantially parallel to each other. Recess 910 may extend the length of door 114 and protrusion 914 may extend the length of door 112.

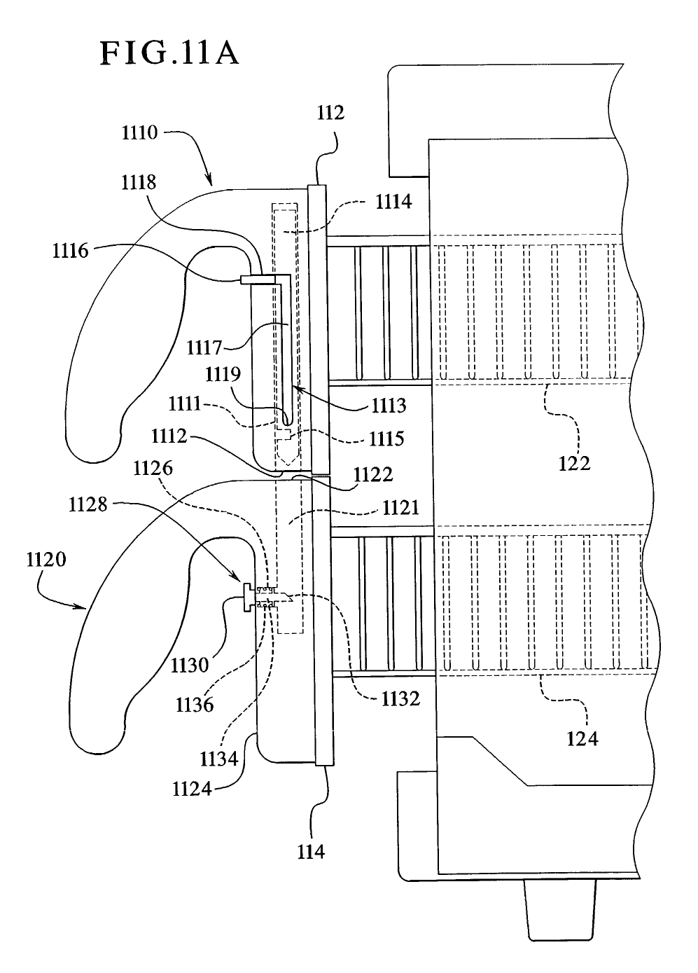

FIGS. 10A-C illustrate an embodiment of handles 1010 and 1020 that have grips 1012 and 1022 which may be removed and replaced by a handgrip 1002 that may be used to open doors 112 and 114 in unison. As shown in FIG. 10A, each handle 1010 and 1020 has a base 1014, 1024 that either grip 1012 and 1014 attaches to so that doors 112 and 114 may be opened independently of one another.

FIG. 10B is a cut-away view of handle 1010 that depicts one implementation for removeably attaching grip 1012 or 1022 to either base 1014 or 1024. In this implementation, each base 1014, 1024 has a cavity 1030 with an opening 1032 and a recess 1034 that extends upward from the cavity 1030. Recess 1034 has an upper wall 1036 with a bore 1038 through the upper wall 1036. Each base 1014 or 1024 also has a tab or pushbutton 1040 that includes a top body 1042, a bottom body 1044, and a stem 1046 that joins the top and the bottom bodies. Each pushbutton 1040 is disposed in base 1014, 1024 such that stem 1046 extends through bore 1038, top body 1042 is above upper wall 1036, and bottom body 1044 is within recess 1034 below upper wall 1036. Both top and bottom bodies 1042, 1044 have a size that is larger than bore 1038 such that upper wall 1036 prevents either body from moving through bore 1038 when pushbutton 1040 is depressed (downward force on top body 1042) or reset (upward force on bottom body 1044) as explained in greater detail below.

Each grip 1012 and 1022 has an arm 1050. Arm 1050 has a protrusion or ridge 1052 that fits up into recess 1034 to retain grip 1012, 1022 to base 1014, 1024 when grip 1012, 1022 is selectively attached to base 1014, 1024. When ridge 1052 is in recess 1034, ridge 1052 resets pushbutton 1040 by forcing bottom body 1044 to move upward in recess 1034 such that pushbutton 1040 is in a reset position. To remove grip 1012, 1022 from base 1014, 1024, a household cook presses on top body 1042 of pushbutton 1040 such that bottom body 1044 forces ridge 1056 to move downward and out of recess 1034. Arm 1050 bends when ridge 1052 is forced down but returns to its original position when no downward force is exerted on ridge 1052. As shown in FIG. 10B, base cavity 1030 has a tapered width to enable arm 1050 to bend when ridge 1052 is forced down and to allow arm 1050 to be removed from opening 1032 of base cavity 1030.

Referring now to FIG. 10C, handgrip 1002 has a top portion 1004 and a bottom portion 1006. Both top portion 1004 and bottom portion 1006 each have an arm 1050 with a ridge 1052. Top and bottom portions 1004 and 1006 are disposed such that each may be removeably attached to bases 1014, 1024 in the same manner as discussed above for removeably attaching grips 1012, 1022 to bases 1014, 1024, respectively. When handgrip 1002 is attached to bases 1014, 1024 doors 112 and 114 may be moved in unison via handgrip 1002. When racks 122, 124 are attached to doors 112, 114 and handgrip 1002 is attached to bases 1014, 1024, handgrip 1002 may be used to remove and carry racks 120, 122 to another location.

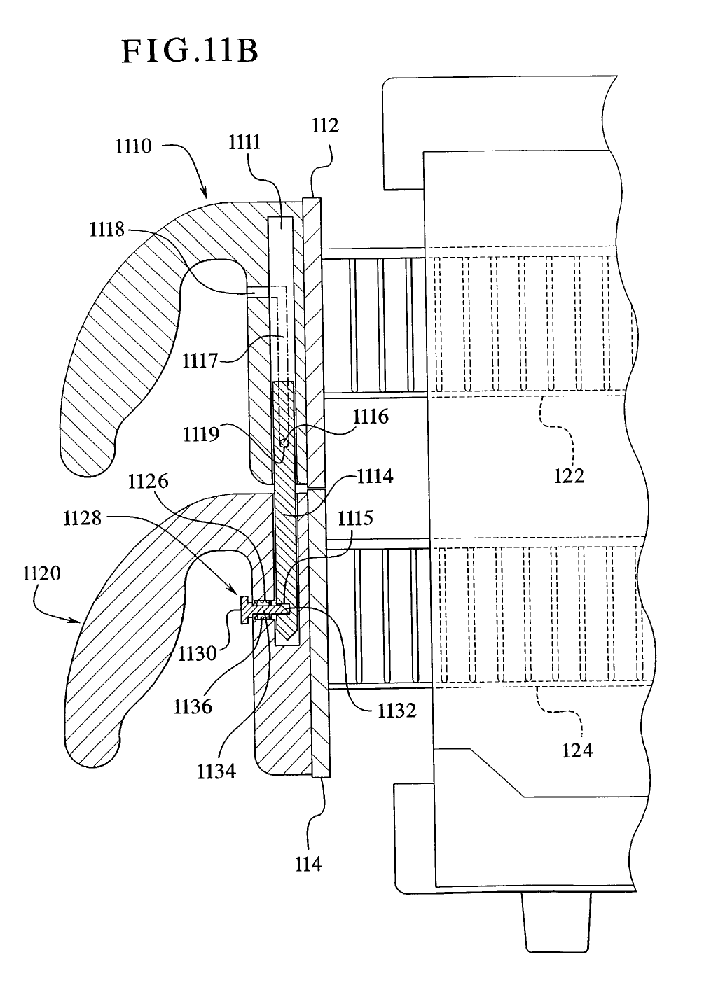

FIGS. 11A-B depict another embodiment of handles 1110 and 1120 that may be used to open doors 112 and 114 in unison. In this implementation, handle 1110 is attached to door 112 and handle 1120 is attached to door 114. Handle 1110 has a cavity 1111 with an opening 1112 that faces downward towards handle 1120. Handle 1120 has a cavity 1121 with an opening 1122 that faces upward and that is in substantial axial alignment with opening 1112 of handle 1110 when doors 112 and 114 are closed. Handle 1110 has a latch 1113 disposed within cavity 1111 such that when extended latch 1113 engages handle 1120 to enable doors 112, 114 to be removed from the oven in unison as described below.

Latch 1113 includes a bolt 1114 that has notch 1115 and a positioning rod 1116 extending from bolt 1114. Cavity 1111 of handle 1110 has a travel path opening 1117 that is adapted to receive and to retain positioning rod 1116 when bolt 1114 is disposed within cavity 1111. Travel path opening 1117 is incorporated into latch 1113. Travel path opening 1117 has two stops 1118 and 1119 to selectively retain positioning rod 1116 such that bolt 1114 is prevented from sliding within cavity 1111.

When positioning rod 1116 is moved to first stop 1118 of travel path opening 1117, bolt 1113 is positioned substantially within cavity 1111 of handle 1110 such that bolt 1114 does not interfere with the independent movement of door 114. When positioning rod 1116 is moved to the second stop 1119 of travel path opening 1117 while handle openings 1112 and 1122 are axially aligned, bolt 1114 slides into cavity 1121 to engage handle 1120.

Handle 1120 also has an outer wall 1124 and a bore 1126 that passes through to cavity 1121 of handle 1120. In addition, handle 1120 includes a pin 1128 that has a head 1130, a protrusion 1132 that tapers away from head 1130, and a stem 1134 that joins head 1130 and tapered protrusion 1132. Pin 1128 is disposed in handle 1120 such that stem 1134 extends through bore 1124, head 1130 is outside of outer wall 1124, and protrusion 1132 is within cavity 1121. Both head 1130 and tapered protrusion 1132 each have a size that is larger than bore 1126 such that outer wall 1124 prevents head and tapered protrusion from moving through bore 1126 when pin 1128 is pulled away from cavity 1121 or pushed towards cavity 1121. Handle 1120 also has a bias member 1136, such as a spring or compressible band, that operably couples pin 1128 to cavity 1121 such that pin 1128 is biased towards cavity 1121 and tapered protrusion 1132 faces up towards cavity opening 1122.

As shown in FIG. 11B, when bolt 1114 slides into cavity 1121 as described above, bolt 1114 exerts a force on tapered protrusion 1132 that causes pin 1128 to move away from cavity 1121, permitting bolt 1114 to pass tapered protrusion 1132 until tapered protrusion 1132 encounters bolt notch 1115. When tapered protrusion 1132 encounters bolt notch 1115, bias member 1136 causes tapered protrusion 1132 to engage bolt notch 1115. With tapered protrusion 1132 engaged in bolt notch 1115, doors 112, 114 may be opened in unison and racks 122 and 124 attached to doors 112 and 114 may be removed from chamber 102 and carried to another location.

To disengage tapered protrusion 1132 from bolt notch 1115, pin head 1130 may be pulled to counter bias member 1136 so that taper protrusion 1132 is moved out of bolt notch 1115. Positioning rod 1116 may then be moved towards first stop 1118 of travel path opening 1117 so that bolt 1114 is positioned substantially within cavity 1111 of handle 1110 and does not interfere with the independent movement of doors 112 and 114.

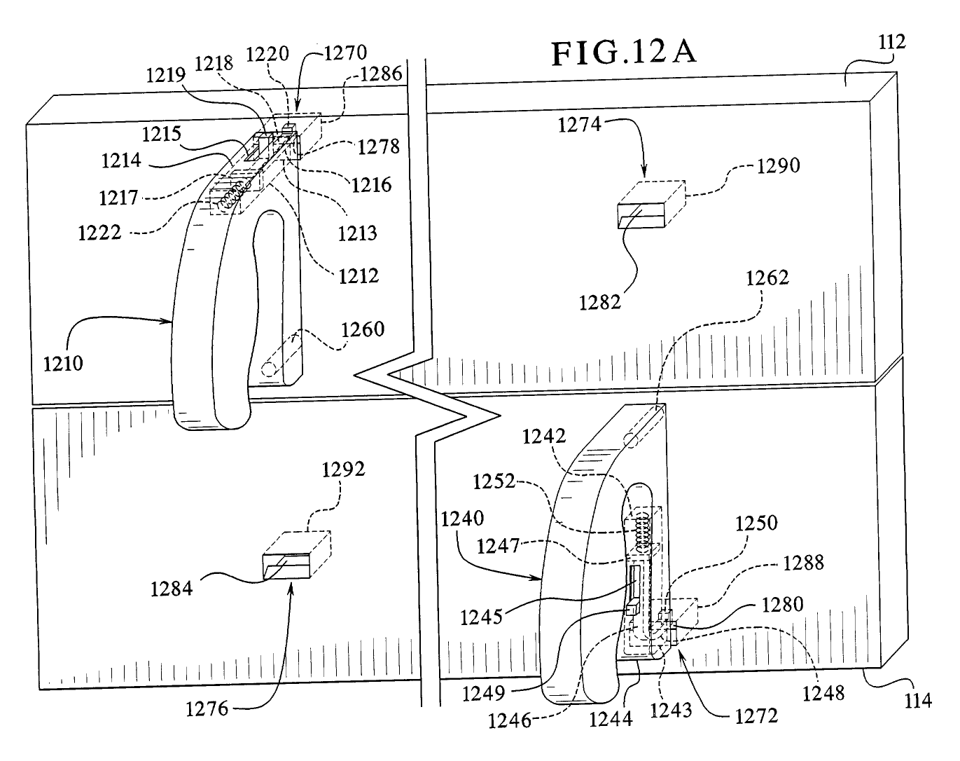

FIGS. 12A-B depict another embodiment of handles 1210 and 1240 that may be used to open doors 112 and 114 in unison. In this implementation, each handle 1210 and 1240 is rotatably attached to a respective door 112, 114 such that each handle 1210, 1240 is removeably attachable to another door 114, 112. As shown in FIG. 12A, each door 112, 114 has a pin 1260, 1262. Each pin 1260, 1262 has one end that is affixed to a respective door 112, 114 and another end that is rotably attached to a respective handle 1210 and 1240.

Each door 112, 114 also has a first cavity 1270, 1272 and a second cavity 1274, 1276. Each cavity 1270, 1272, 1274, and 1276 has a respective opening 1278, 1280, 1282, and 1284 and a respective internal recess 1286, 1288, 1290, and 1292. To facilitate handles 1210, 1240 being removeably attachable to another door, the first cavity 1270, 1272 of each door 112, 114 is axially aligned with and preferably mirrors the second cavity 1276, 1274 of the other door 114, 112.

Each handle 1210, 1240 has a bore 1212, 1242 with a bore opening 1213, 1243 that may be aligned with first cavity 1270, 1272 of door 112, 114 when handle 1210, 1240 is rotated into a first position as shown in FIG. 12A. Conversely, bore opening 1213, 1243 may be aligned with second cavity 1274, 1276 when handle 1210, 1240 is rotated into a second position as shown in FIG. 12B. Each handle 1210, 1240 also has an outer wall 1214, 1244 and a travel path opening 1215, 1245 through outer wall 1214, 1244 to bore 1212, 1242. In addition, each handle 1210, 1240 has an arm 1216, 1246 adapted to slide or move within bore 1212, 1242. Each arm 1216, 1246 has a wide portion 1217, 1247 and a thin portion 1218, 1248 that extends from wide portion 1217, 1227 towards bore opening 1213, 1243. Each arm 1216, 1246 also has a tab 1219, 1249 disposed on thin portion 1218, 1248 to extend through travel path opening 1215, 1245 of handle 1210, 1240. Thin portion 1218 is adapted to bend momentarily when tab 1219 is pushed to release or removeably detach handle 1210 from door 112 so handle 1210 may be rotated about pin 1260 as explained in greater detail below. Similarly, thin portion 1248 is adapted to bend momentarily when tab 1249 is pulled to release or removeably detach handle 1240 from door 114 so handle 1240 may be rotated about pin 1262.

Arm 1216 also has a ridge 1220 or protrusion that is adapted to fit into recess 1286 to removeably attach handle 1210 just to door 112 when handle 1210 is selectively rotated to the first position (as shown in FIG. 12A) or to fit into recess 1292 to removeably attach handle 1210 to both doors 112 and 114 when handle is selectively rotated to the second position (as shown in FIG. 12B). Similarly, arm 1246 has a ridge or protrusion 1250 that is adapted to fit into recess 1290 to removeably attach handle 1240 just to door 114 when handle 1240 is selectively rotated to the first position (as shown in FIG. 12A) or to fit into recess 1288 to removeably attach handle 1240 to both doors 112 and 114 when handle is selectively rotated to the second position (as shown in FIG. 12B).

Each handle also includes a bias member 1222, 1252 (e.g., a spring or compressible band) disposed within bore 1212, 1242. Bias member 1222, 1252 operably couples arm 1216, 1246 to bore 1212, 1242 such that ridge 1220, 1250 is biased to extend beyond bore opening 1213, 1243 to fit in (or engage) recess 1292, 1290 when handle 1210, 1240 is rotated to the first position or to fit in (or engage) recess 1264, 1262 when handle 1210, 1220 is rotated to the second position. When ridge 1222, 1252 is engaged in recess 1292, 1290, doors 112, 114 may be opened in unison and racks 122 and 124 attached to doors 112 and 114 may be removed from chamber 102 and carried to another location.

To removeably detach handle 1210 when ridge 1218 is in recess 1286 (i.e., handle 1210 is attached just to door 112) or is in recess 1292 (i.e., handle 1210 is attached to both doors 112, 114), tab 1219 is pushed to momentarily bend thin portion 1218 of arm 1216 such that ridge 1222 is pulled out of the respective recess. To removeably detach handle 1240 when ridge 1252 is in recess 1288 (i.e., handle 1240 is attached just to door 114) or is in recess 1290 (i.e., handle 1240 is attached to both doors 112, 114), tab 1249 is pulled to momentarily bend thin portion 1248 of arm 1246 such that ridge 1252 is pulled out of the respective recess. Tabs 1219 and 1249 may each be pulled back within the respective travel path opening 1215 and 1245 to free arms 1216 and 1246 from the respective cavity so that handles 1210 and 1240 may be rotated about pins 1260 and 1262.

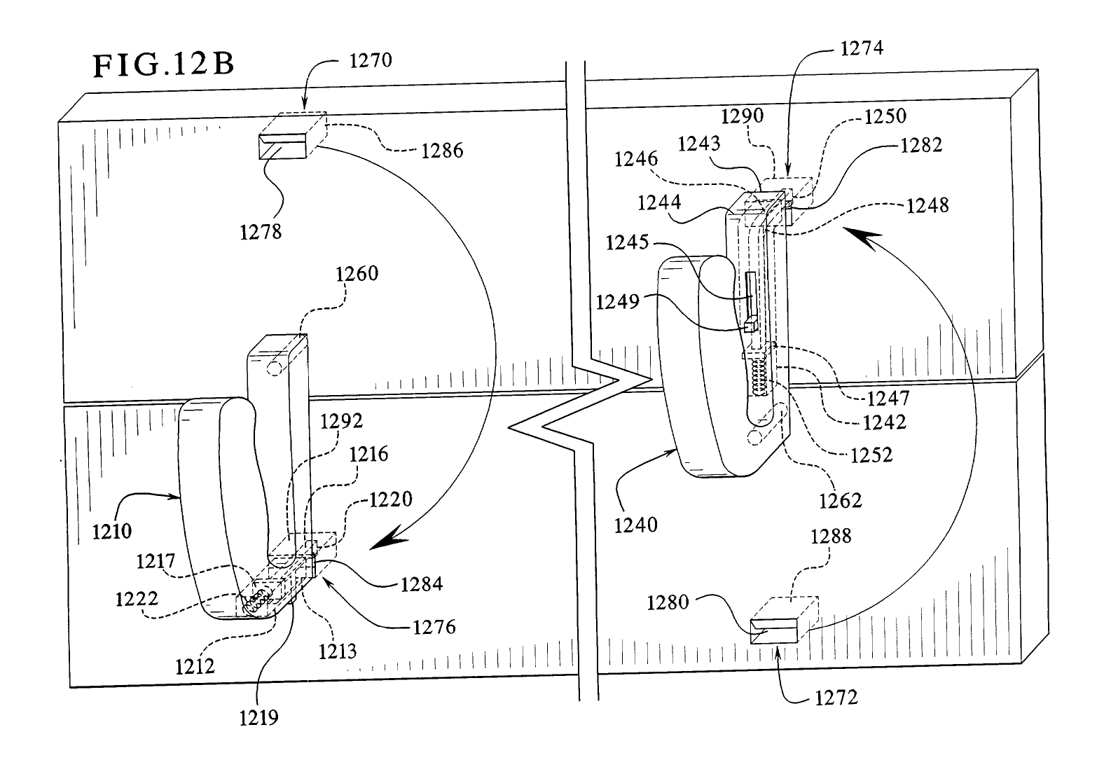

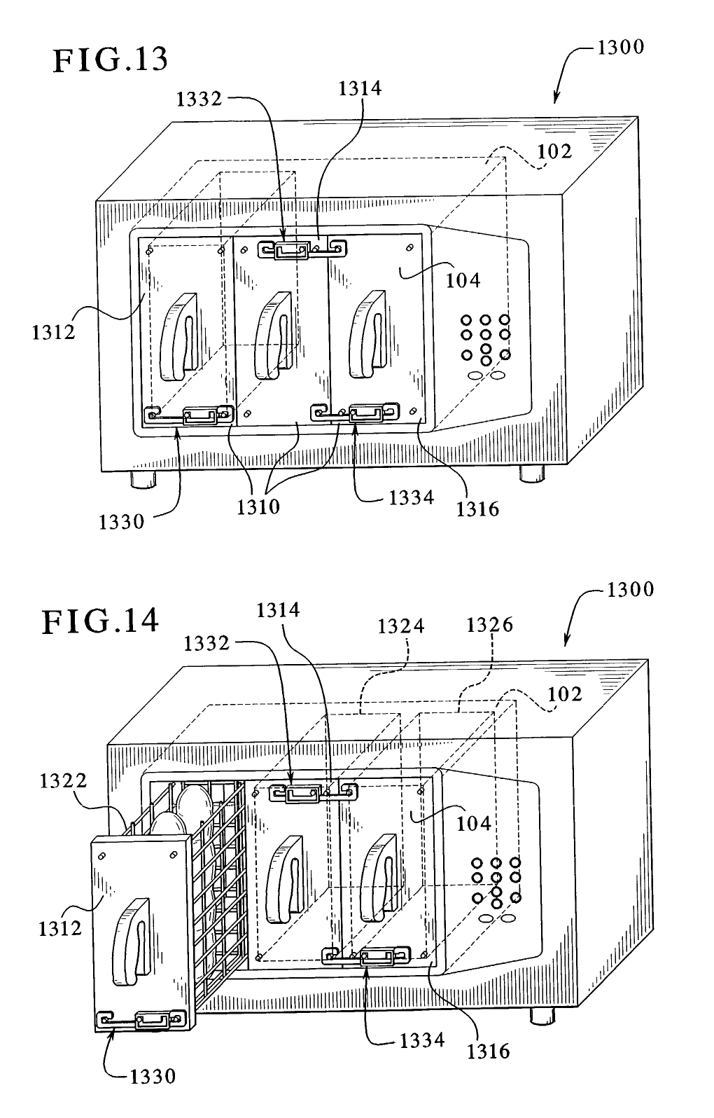

FIGS. 13 and 14 depict a perspective view of another embodiment of oven 1300 that includes a group of independently moveable doors 1310 positioned along a horizontal axis of the oven 1300. Each door 1312, 1314 and 1316 covers a portion of the chamber opening 104 and selectively controls access through the chamber opening 104 to a respective portion of the heating chamber 102.

In the implementation shown in FIGS. 13 and 14, the doors 1312, 1314 and 1316 are disposed side-by-side along a horizontal axis of oven 1300 such that heat within the chamber is at least partially inhibited from escaping between the doors 1312, 1314 and 1316. In another implementation, oven 1300 may have a group of vertical cross members (not shown in figures) that connect opposing sides of chamber opening 104 so that the doors 1312, 1314 and 1316 may be spaced apart and still retain heat within the chamber when the doors 1312, 1314 and 1316 are closed.

Oven 1300 also includes a group of racks 1320. Each rack 1322, 1324, and 1326 is attached to a respective door 1312, 1314, and 1316. Racks 1320 may be identical to racks 120 in FIG. 1 in make, except each rack 1322, 1324, and 1326 does not have a width that spans the width of the chamber. In addition, chamber 102 may include a bottom wall upon which each rack 1322, 1324, and 1326 may rest when doors 1312, 1314, and 1316 are closed to cover chamber opening 104. In another implementation, chamber 102 may include hangers (not shown in figures) attached to a top wall of chamber 102 that are adapted to receive and selectively retain racks 1322, 1324, and 1326 within chamber 102 when doors 1312, 1314, and 1316 are closed.

As shown in FIGS. 13 and 14, each rack 1322, 1324, and 1326 may be a basket that preferably extends a height of the attached door 1312, 1314, and 1316. Thus, in this implementation, a household cook is able to heat more food items vertically on racks 1312, 1314, and 1316.

Oven 1300 may also include a group of latches 1330, 1332, and 1334 for removing in unison at least two of doors 1312, 1314, and 1316 from chamber 102. Each latch 1330, 1332, and 1334 is attached to a respective door 1312, 1314, and 1316 and are adapted like latch 750 in FIG. 7 to be engage at least one other door so that the doors 1312, 1314, and 1316 may be moved in unison. In the implementation shown in FIG. 13, each door 1312, 1314, and 1316 has a respective knob that latch 1330, 1332, and 1334 may selectively engage to allow doors 1312, 1314, and 1316 to be moved in unison and to allow racks 1322, 1324, and 1326 to be completely removed from chamber 102 and carried to another location (e.g., where food items held on racks 1322, 1324, and 1326 may be easily accessed by a household cook).

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A heating apparatus comprising:
a single heating chamber having an opening; and
a plurality of independently moveable doors, each door covers a portion of the chamber opening and selectively controls access through the chamber opening to a respective portion of the heating chamber.

2. The apparatus of claim 1, further comprising a heating element operably connected to heat the chamber when in an operating state and to automatically turn to an off state when one of the doors are opened to allow access to the respective portion of the heating chamber.

3. The apparatus of claim 1, wherein each door is pivotably mounted to the chamber.

4. The apparatus of claim 3, wherein each door is hinged to pivot about one side of the door and the apparatus further comprises a means for opening at least two doors in unison.

5. The apparatus of claim 3, wherein one of the doors is hinged on a vertical axis of the chamber opening while another of the doors is hinged on a horizontal axis of the chamber opening.

6. The apparatus of claim 1, further comprising a plurality of racks, each rack is adapted to hold an item to be heated and to be disposed within the chamber such that a respective one of the racks is accessible when one of the plurality of doors is opened while the remaining one or more doors are closed to prevent access.

7. The apparatus of claim 6, wherein each rack is removable.

8. The apparatus of claim 6, wherein the one rack is attached to a respective one of the plurality of doors such that the one rack is at least partially removed from the chamber as the respective one of the plurality of doors is opened and the one rack is completely disposed within the chamber when the respective one of the plurality of doors is closed to cover the respective portion of the opening.

9. The apparatus of claim 8, wherein each rack is attached to a respective one door such that each rack and respective attached door is removable from the chamber and is interchangeable with another rack attached to another door.

10. The apparatus of claim 8, wherein the one rack is a basket.

11. The apparatus of claim 8, wherein at least two of the plurality of doors are disposed side-by-side along a horizontal axis of the chamber opening.

12. The apparatus of claim 11, wherein heat within the chamber is at least partially inhibited from escaping between the at least two doors of the plurality of doors when the two doors are closed.

13. The apparatus of claim 8, wherein at least two of the plurality of doors are disposed side-by-side along a vertical axis of the chamber opening.

14. The apparatus of claim 13, wherein heat within the chamber is at least partially inhibited from escaping between the at least two doors of the plurality of doors when the two doors are closed.

15. The apparatus of claim 8, further comprising a means for removing in unison two or more of the plurality of doors.

16. The apparatus of claim 15, wherein another one of the plurality of doors has a rack attached thereto such that both attached racks are also removed in unison.

17. The apparatus of claim 15, wherein the means for removing comprises a latch disposed on the one door and adapted to extend to engage another door so that the two doors move in unison.

18. The apparatus of claim 15, further comprising a plurality of handles, each of the handles being associated with a respective one of the plurality of doors.

19. The apparatus of claim 18, wherein the means for removing comprises a handgrip configured to be removeably attached to both the first handle and the second handle so that the first and the second handle move in unison.

20. The apparatus of claim 18, wherein a first handle and a second handle of the plurality of handles each has a respective base and a respective grip removeably attached to the respective grip, the base of the first handle is attached to the one door and the base of the second handle is attached to the second door, and the removing means includes a handgrip adapted to be removeably attached to both the first handle base and the second handle base after the first and the second handle grips are removed therefrom so that the one and second doors move in unison.

21. The apparatus of claim 18, wherein the first handle is substantially aligned with the second handle and the means for removing includes a latch disposed in association with the first handle and adapted to extend to engage the second handle so that the two handles move in unison.

22. The apparatus of claim 18, wherein the removing means includes both a first handle and a second handle each being rotatably attached to a respective door such that each is removeably attachable to another door.

23. The apparatus of claim 6, wherein at least two of the plurality of doors are disposed side-by-side such that heat within the chamber is at least partially inhibited from escaping between the at least two doors of the plurality of doors when the two doors are closed.

24. The apparatus of claim 6, wherein when one of the doors is opened to allow access, heat from portions of the chamber not accessible via the one door is at least partially inhibited from escaping through the chamber opening.
